(19) United States
(12) Patent Application Publication
(10) Pub. No.: US 2012/0259829 A1
(43) Pub. Date: Oct. 11, 2012

(54) GENERATING RELATED INPUT SUGGESTIONS

(76) Inventor: Xin Zhou, Beijing (CN)

(21) Appl. No.: 13/517,241

(22) PCT Filed: Dec. 30, 2009
(86) PCT No.: PCT/CN09/01583

§ 371 Date: Jun. 19, 2012

(51) Int. Cl. G06F 17/30

(52) U.S. Cl. 707/706; 707/E17.108

(57) ABSTRACT

Methods, systems, and apparatus, including computer program products, for generating search query suggestions. In one aspect, a method includes receiving query and label data, the data including a plurality of queries and, for each query, specifying one or more labels associated with the query, where the queries are n grams submitted by users of a search engine and the labels identify a category or topic in which an associated query belongs; generating a suggestion resource, including: identifying unique labels in the query and label data; and for each unique label: indexing the unique label; identifying in the query and label data, each query associated with the unique label; and associating, in the suggestion resource, the identified queries with the unique label; and storing the suggestion resource in a computer readable medium.

### BACKGROUND

This specification relates to digital data processing, and in particular, to computer-implemented search services.

Conventional search services provide search query suggestions as alternatives to input search queries. For example, a conventional search engine can include a query input field that receives an input search query. In response to receiving the input search query, a conventional search service can provide search query suggestions for the input search query. A user can select a search query suggestion for use as a search query.

Some search services determine search query suggestions by matching the input search query with search query suggestions. In particular, the search query suggestions that are provided by these search services are typically partial textual matches of the input search query, e.g., where the input search query is a substring of each of the search query suggestions. The quality of the search query suggestions can depend on the amount, precision, and accuracy of data that is used to generate the search query suggestions.

### SUMMARY

This specification describes technologies relating to generation of search query suggestions.

In general, one aspect of the subject matter described in this specification can be embodied in methods that include the actions of receiving query and label data, the data including a plurality of queries and, for each query, specifying one or more labels associated with the query, where the queries are n-grams submitted by users of a search engine and the labels identify a category or topic in which an associated query belongs; generating a suggestion resource, including: identifying unique labels in the query and label data; and for each unique label: indexing the unique label; identifying in the query and label data, each query associated with the unique label; and associating, in the suggestion resource, the identified queries with the unique label; and storing the suggestion resource in a computer-readable medium. Other embodiments of this aspect include corresponding systems, apparatus, and computer program products.

The foregoing and following embodiments can optionally include one or more of the following features. The method further includes receiving a textual input entered in a search engine query input field by a user; and identifying input suggestions using the query and label data including: comparing the textual input to the queries in the query and label data to identify a first query that the textual input represents; and identifying the one or more labels that are associated with the first query as being selectable alternatives to the textual input. The input suggestions are identified as characters are entered in the search engine query input field and before a complete query is submitted for a search.

The method further includes receiving a textual input entered in a search engine query input field by a user; and identifying input suggestions using the suggestion resource including: comparing the textual input to the indexed labels in the suggestion resource to identify a first indexed label that the textual input represents; and identifying the one or more queries associated with the first indexed label as being selectable alternatives to the textual input. The method further includes comparing each query identified as being a selectable alternative to the queries in the query and label data to identify a first query that is textually identical to the query identified as being a selectable alternative; and identifying the one or more labels that are associated with the first query as being selectable alternatives to the textual input.

The textual input is not a substring of any of the selectable alternatives. The textual input is a prefix, midfix, or suffix of at least one of the selectable alternatives. Identifying the first indexed label includes: determining whether the textual input is a prefix of the first indexed label and determining that the first indexed label is represented by the textual input when the textual input is a prefix of the first index label. The queries are associated with at least one label that is not a substring of the associated query.

In general, another aspect of the subject matter described in this specification can be embodied in methods that include the actions of receiving a textual input entered in a search engine query input field by a user; and identifying input suggestions using a suggestion resource, the suggestion resource including an index of labels, each label being associated with one or more queries and identifying a category or topic in which an associated query belongs; where the identifying includes: comparing the textual input to the indexed labels in the suggestion resource to identify a first indexed label that the textual input represents; and identifying the one or more queries associated with the first indexed label as being selectable alternatives to the textual input. Other embodiments of this aspect include corresponding systems, apparatus, and computer program products.

Particular embodiments of the subject matter described in this specification can be implemented to realize one or more of the following advantages. Providing related input suggestions reduces how much user interaction is required to obtain suggestions for an input search query and perform searches using one or more of the suggestions. In addition to saving time, providing related suggestions can increase the precision, accuracy, and coverage of searches by refining a query before the query is submitted and capturing suggestions that are directed to, e.g., particularly relevant to, a particular topic but are not necessarily textual matches of the input search query.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example of a flow of data in some implementations of a system that generates input suggestions.

FIG. 2 is a block diagram of an example suggestion server.

FIG. 3 includes block diagrams illustrating examples of the first suggestion resource and the second suggestion resource.

FIG. 4 is a flow chart showing an example process for generating a suggestion resource.

FIG. 5 is a flow chart showing an example process for identifying input suggestions.

FIG. 6 is a flow chart showing another example process for identifying input suggestions.

FIG. 7 is a flow chart showing another example process for identifying input suggestions.

Like reference numbers and designations in the various drawings indicate like elements.

### DETAILED DESCRIPTION

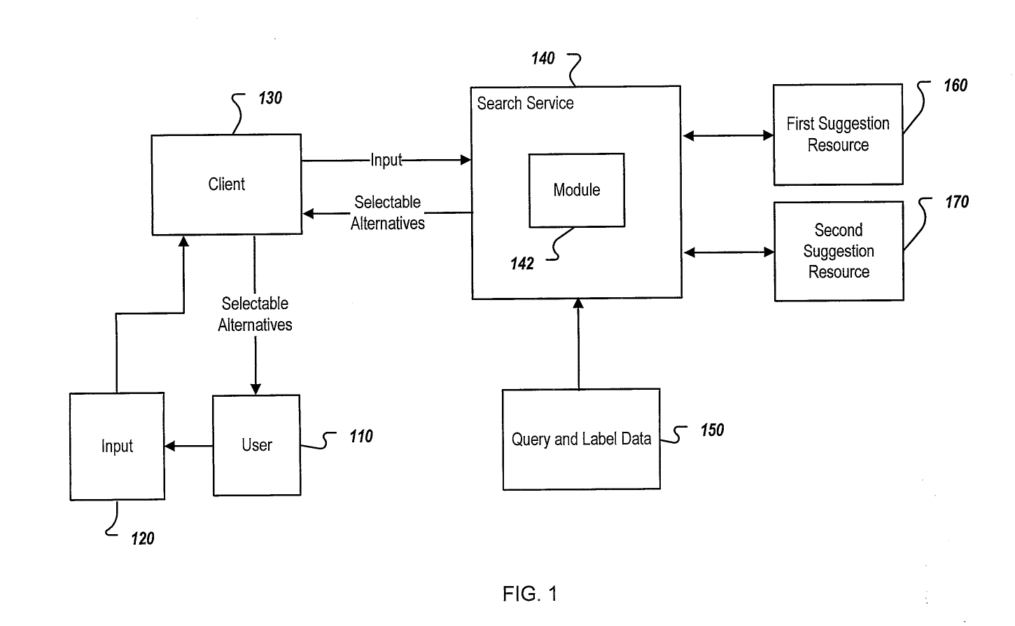

FIG. 1 is a block diagram illustrating an example of a flow of data in some implementations of a system that generates input suggestions. A user 110 provides input 120 to a search engine query input field presented by a client 130. The input 120 is textual input that includes one or more n-grams.

An n-gram is a sequence of n consecutive tokens, e.g., characters or words. An n-gram has an order, which is a number of tokens in the n-gram. For example, a 1-gram (or unigram) includes one token; a 2-gram (or bi-gram) includes two tokens. Examples of a 2-gram include “at”, which includes two characters, and “all terrain”, which includes 2 words.

The client 130 sends to a search service 140 a request for selectable alternatives of the input 120. The request includes the input 120. In some implementations, the client 130 sends the request after receiving each token of a textual input, e.g., after each character of a first search query or each word of a first search query, is received at the search engine query input field. As a result, selectable alternatives can be provided to the user as the user types each token of the textual input, and before a complete query is submitted for a search. In some alternative implementations, the client 130 implements a delay, waiting a predetermined amount of time before automatically making the request to the search service 140.

A module 142, e.g., a software script, installed on the search service 140 receives the input 120 and determines selectable alternatives to the input 120 using query and label data 150. In particular, the module 142 receives the query and label data 150. The query and label data 150 includes a collection of queries. For each query, the query and label data 150 also specifies one or more labels that are associated with the query. A label can identify a category or topic in which a query belongs. Conventional techniques can be used to generate the query and label data 150, and the query and label data 150 can be provided to the search service 140.

In some implementations, the query and label data 150 is generated using web log analysis. For example, web logs can be parsed to extract the queries, e.g., n-grams submitted by users of a search engine. Then, labels can be associated with each of the extracted queries. For example, a collection of queries can include the n-grams “men's clothing”, “women's clothing”, “jewelry”, “used cars”, “toys”, “groceries”, “celery”, “broccoli”, and “carrots”. An example label that can be associated with each of the n-grams “men's clothing”, “women's clothing”, “jewelry”, “used cars”, “toys”, and “groceries”, is “shopping”. As another example, an example label that can be associated with each of the n-grams “groceries”, “celery”, “broccoli”, and “carrots”, is “food”. In addition, an example label “vegetables” can also be associated with the n-grams “celery”, “broccoli”, and “carrots”.

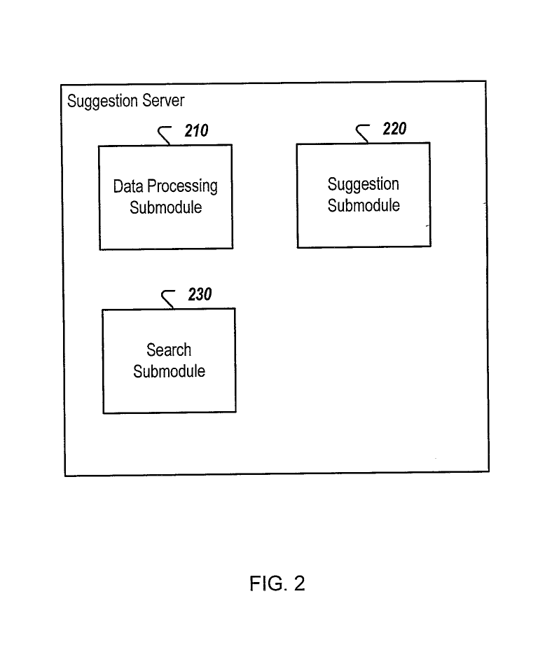

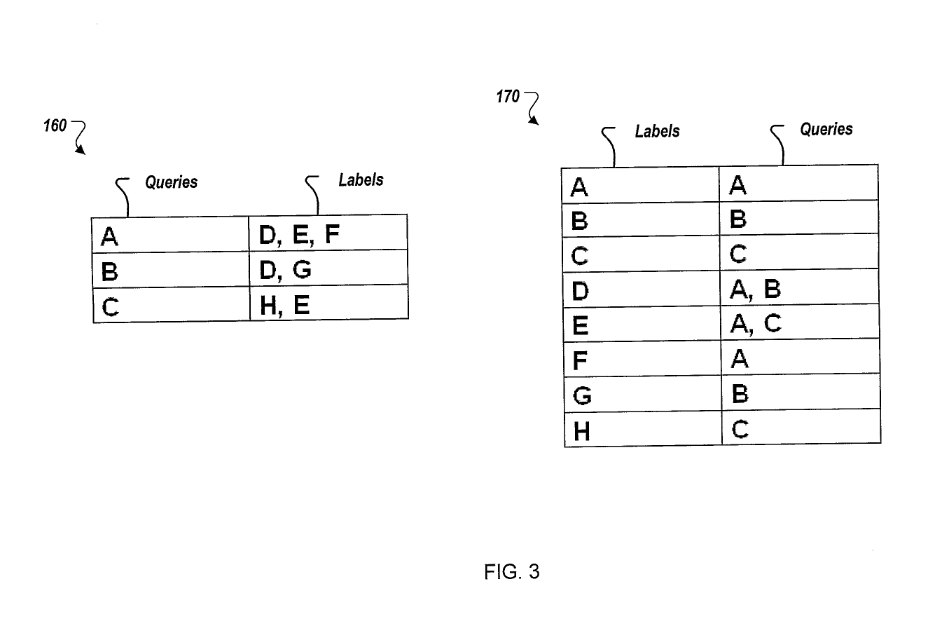

As described in further detail below with respect to FIGS. 2 and 3, the module 142 can receive the query and label data 150 and generate a first suggestion resource 160 and a second suggestion resource 170, and the module 142 can also use the first suggestion resource 160 and the second suggestion resource 170 to determine selectable alternatives to the input 120. In particular, the first suggestion resource 160 is a representation of the query and label data 150. The first suggestion resource 160 and the second suggestion resource 170 can be represented using a same type of data structure or format to facilitate processing. The query and label data 150 and the first suggestion resource 160 can be used interchangeably, e.g., depending on processing efficiency and needs.

FIG. 2 is a block diagram of an example suggestion server, e.g., an example of module 142. The suggestion server includes a data processing submodule 210, a suggestion submodule 220, and a search submodule 230. The data processing submodule 210 receives and processes the query and label data 150 to identify queries and labels and provide the identified queries and labels to the suggestion submodule 220 that in turn, generates the first suggestion resource 160 and the second suggestion resource 170.

FIG. 3 includes block diagrams illustrating examples of the first suggestion resource 160 and the second suggestion resource 170. The first suggestion resource 160 and second suggestion resource 170 can be represented using different types of data structures or formats. Example formats of the suggestion resources include Extensible Markup Language (XML), JavaScript Object Notation (JSON), line-by-line, and protocol buffers. The module 142 parses the query and label data 150 to identify the queries and labels associated with each of the queries.

In the example of FIG. 3, “A”, “B”, and “C” represent queries. In addition, “D”, “E”, “F”, “G”, “H” represent labels. Note that, in the example, the queries and labels are represented by a single capital letter. In practice, each query and label is a sequence of text that includes one or more n-grams.

The data processing submodule 210 receives query and label data that includes the queries “A”, “B”, and “C” and the labels “D”, “E”, “F”, “G”, and “H”. The data processing submodule 210 identifies each query and labels associated with the query. For example, data processing submodule 210 processes the query and label data 150 to identify that “A” is a query and is associated with-the labels “D”, “E”, and “F”; “B” is a query and is associated with the labels “D” and “G”; and “C” is a query and is associated with the labels “H” and “E”.

The data processing submodule 210 provides the identified queries and their respective associated labels to the suggestion submodule 220. The suggestion submodule 220 generates the first suggestion 160 resource. In some implementations, the suggestion submodule 220 generates an index, where each of the indices in the index is a query. In FIG. 3, the indices are represented by the queries “A”, “B”, and “C”. The suggestion submodule 220 associates each of the indices with one or more labels specified as being associated with the respective index. For example, the index represented by query “A” is associated with the labels “D”, “E”, and “F”; the index represented by query “B” is associated with the labels “D” and “G”; and the index represented by query “C” is associated with the labels “H” and “E”.

In some implementations, the first suggestion resource 160 is represented using a protocol buffer. A protocol buffer is a language and platform neutral, extensible technique for serializing structured data, e.g., by encoding structured data according to Google's data interchange format, Protocol Buffers.

To generate the second suggestion resource 170, the module 142 identifies unique labels, e.g., each different label included in the query and label data 150, to generate an index of unique labels. As an example, although the query and label data 150 or the first suggestion resource 160 may include multiple entries of the label “D”, because the label “D” is associated with both queries “A” and “B”, only one of the indices in the second suggestion resource 170 is represented by the label “D”. In the example of FIG. 3, the unique labels “D”, “E”, “F”, “G”, and “H” are identified and used to generate an index of the second suggestion resource 170. In some implementations, the unique labels are directly identified by the data processing submodule 210 from the query and label data 150. In some alternative implementations, the unique labels are identified from the first suggestion resource 160. When the unique labels are identified from the first suggestion resource 160, the generation of the second suggestion resource 170 can be referred to as “reverse mapping” the queries to the unique labels.

In particular, each query associated with the unique label is also identified from the query and label data 150 or the first suggestion resource 160. Each query identified as being associated with a label is associated, in the second suggestion resource 170, with the index that represents the associated label. In the example of FIG. 3, the index represented by the label “D” is associated with the queries “A” and “B”; the index represented by the label “E” is associated with the queries “A” and “C”; the index represented by the label “F” is associated with the query “A”; the index represented by the label “G” is associated with the query “B”; and the index represented by the label “H” is associated with the query “C”.

In some implementations, each query from the query and label data 150, or the first suggestion resource 160, can also be used to generate a corresponding label and an index, in the second suggestion resource 170, represented by the corresponding label. Each of these indices is associated, in the second suggestion resource 170, with the query from which the index was generated. In the example of FIG. 3, the index represented by the label “A” is associated with the query “A”, the index represented by the label “B” is associated with the query “B”, and the index represented by the label “C” is associated with the query “C”.

When the module 142 receives a request for input suggestions, including a textual input entered in a search engine query input field by a user, the search submodule 230 can identify input suggestions that can be used as selectable alternatives to the input query. The search submodule 230 can search the query and label data 150, the first suggestion resource 160, and the second suggestion resource 170 to identify the input suggestions, e.g., related input suggestions. The input suggestions can be referred to as “related” because they are not necessarily partial textual matches of the textual input, e.g., a prefix, midfix, or suffix of the textual input, but are related to the textual input, e.g., identify or belong to a category or topic in which the textual input belongs. In some implementations, one or more of the input suggestions are partial textual matches of the textual input.

In some implementations, the search submodule 230 compares the textual input to the query and label data 150 or the first suggestion resource 160 to identify queries that the textual input represents. A query can be considered to be representative of the textual input, for example, if the query is textually identical to the textual input, or a partial match of the textual input, e.g., the textual input is a substring of the query (e.g., a prefix, midfix, or suffix of the query) or the query is an expansion of the textual input (e.g., an acronym, an abbreviation). As other examples, a query can be considered representative of the textual input if the query is a translation or transliteration of the textual input. The labels that are associated with each of the identified queries are identified as being selectable alternatives to the textual input.

In some implementations, the search submodule 230 compares the textual input to the indexed labels in the second suggestion resource 170 to identify indexed labels that the textual input represents. As similarly described above with respect to queries being representative of the textual input, an indexed label can be considered to be representative of the textual input, for example, if the indexed label is textually identical to the textual input, or a partial match of the textual input, e.g., the textual input is a substring of the indexed label (e.g., a prefix, midfix, or suffix of the indexed label) or the indexed label is an expansion of the textual input (e.g., an acronym, an abbreviation). As other examples, a label can be considered representative of the textual input if the label is a translation or transliteration of the textual input. The queries that are associated with each of the indexed labels are identified as being selectable alternatives to the textual input.

Additional selectable alternatives can be identified using the queries initially identified as being selectable alternatives to the textual input. In some implementations, additional iterations of searching the first resource 160 to identify first labels as selectable alternatives, searching the second resource 170 to identify first queries associated with the first labels as being selectable alternatives, and again searching the first resource 160 to identify second labels that are associated with the first queries as being selectable alternatives, i.e., the additional selectable alternatives.

As an example, in FIG. 3, query “A” (e.g., “shopping”) can be representative of a textual input (e.g., “sho”) entered in a search engine query input field by a user. The search submodule 230 compares the textual input to the queries in the first suggestion resource 150, identifies that query “A” is representative of the textual input, and further identifies the labels “D” (e.g., groceries), “E” (e.g., used cars), and “F” (e.g., “men's clothing”) associated with query “A” as being selectable alternatives to query “A”.

In addition, the search submodule 230 can search the second resource 170 by comparing the textual input to the labels in the second suggestion resource, identifying that label “G” (e.g., “shops”) is representative of the textual input, and further identifying query “B” (e.g., “Mail-order flowers”) as being a selectable alternative to query “A”.

The search submodule 230 can also compare the queries identified as being selectable alternatives to the textual input, e.g., query “B”, to the query and label data 150 or the first suggestion resource 160 to identify a first query that is textually identical. The labels associated with the first query can be identified as being selectable alternatives to the textual input. For example, the index represented by query “B” in the first suggestion resource 160 can be identified, and the labels associated with query “B”, i.e., labels “D” and “G”, can be identified as being selectable alternatives to the textual input. As an example, label “D” can be the label “florists” and label “G” can be the label “flower shops”.

As a result, the selectable alternatives “groceries”, “used cars”, “men's clothing”, “Mail-order flowers”, “florists”, and “flower shops” can be identified for the textual input “sho” (which may represent “shopping”). In some implementations, “shopping” and “shops”, e.g., queries that correspond to query “A” and label “G”, respectively, are also identified as being selectable alternatives to the textual input “sho”.

The module 142 sends the selectable alternatives to the client 130. In some implementations, the selectable alternatives are further processed such that only a subset of the selectable alternatives, is provided to the client 130. For example, duplicates, i.e., textually identical selectable alternatives, can be removed. As another example, each selectable alternative can be ranked based on rankings, e.g., scores, specified in the query and label data 150. In some implementations, the ranking is related to the quality of the selectable alternative, e.g., how relevant the selectable alternative is to a query.

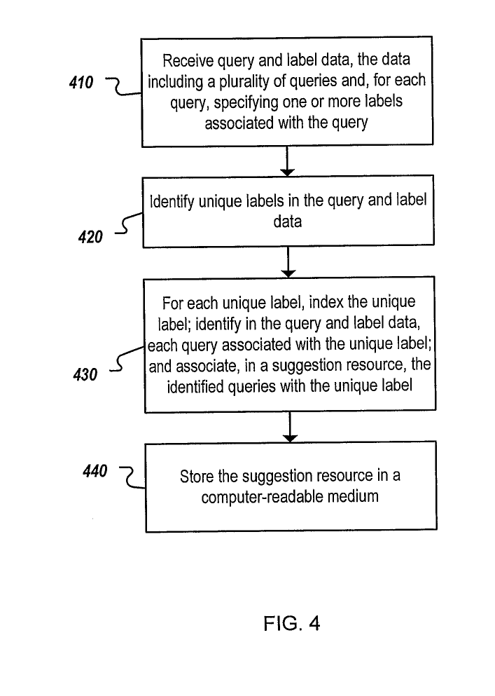

FIG. 4 is a flow chart showing an example process for generating a suggestion resource. The process can be implemented in the module 142. The process includes receiving query and label data, the data including a plurality of queries and, for each query, specifying one or more labels associated with the query (410). The queries are n-grams submitted by users of a search engine and the labels identify a category or topic in which an associated query belongs. A suggestion resource (e.g., second suggestion resource 170) is generated. Generating the suggestion resource includes identifying unique labels in the query and label data (420). Generating the suggestion resource also includes, for each unique label, indexing the unique label; identifying in the query and label data, each query associated with the unique label; and associating, in the suggestion resource, the identified queries with the unique label (430). The process also includes storing the suggestion resource in a computer-readable medium (440).

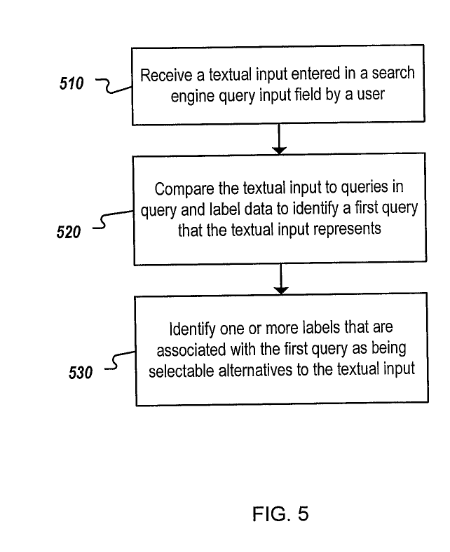

FIG. 5 is a flow chart showing an example process for identifying input suggestions. The process can be implemented in the module 142. The process for identifying input suggestions can be performed after the process described with respect to FIG. 4. The process includes receiving a textual input entered in a search engine query input field by a user (510). Input suggestions are identified using the query and label data. Identifying the input suggestions includes comparing the textual input to the queries in the query and label data to identify a first query that the textual input represents (520). Identifying the input suggestions also includes identifying the one or more labels that are associated with the first query as being selectable alternatives to the textual input (530).

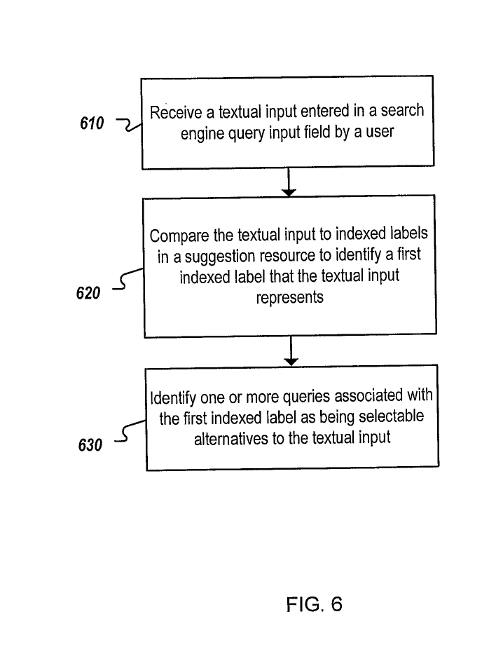

FIG. 6 is a flow chart showing another example process for identifying input suggestions. The process can be implemented in the module 142. The process for identifying input suggestions can be performed after the process described with respect to FIG. 4. The process includes receiving a textual input entered in a search engine query input field by a user (610). Input suggestions are identified using a suggestion resource. Identifying the input suggestions includes comparing the textual input to indexed labels in the suggestion resource to identify a first indexed label that the textual input represents (620). Identifying the input suggestions also includes identifying one or more queries associated with the first indexed label as being selectable alternatives to the textual input (630).

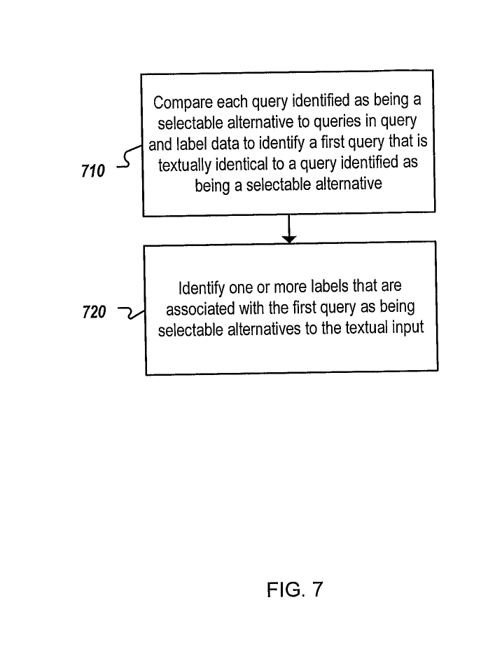

FIG. 7 is a flow chart showing another example process for identifying input suggestions. The process can be implemented in the module 142. The process for identifying input suggestions can be performed after the process described with respect to FIG. 6. The process includes comparing each query identified as being a selectable alternative to the queries in the query and label data to identify a first query that is textually identical to the query identified as being a selectable alternative (710). The process also includes identifying the one or more labels that are associated with the first query as being selectable alternatives to the textual input (720).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving query and label data, the data including a plurality of queries and, for each query, specifying one or more labels associated with the query, wherein the queries are n-grams submitted by users of a search engine and the labels identify a category or topic in which an associated query belongs;
generating a suggestion resource, including:
identifying unique labels in the query and label data; and
for each unique label:
indexing the unique label;
identifying in the query and label data, each query associated with the unique label; and
associating, in the suggestion resource, the identified queries with the unique label; and
storing the suggestion resource in a computer-readable medium.

2. The method of claim 1, further comprising:
receiving a textual input entered in a search engine query input field by a user; and
identifying input suggestions using the query and label data including:
comparing the textual input to the queries in the query and label data to identify a first query that the textual input represents; and
identifying the one or more labels that are associated with the first query as being selectable alternatives to the textual input.

3. The method of claim 2, wherein the input suggestions are identified as characters are entered in the search engine query input field and before a complete query is submitted for a search.

4. The method of claim 1, further comprising:
receiving a textual input entered in a search engine query input field by a user; and
identifying input suggestions using the suggestion resource including:
comparing the textual input to the indexed labels in the suggestion resource to identify a first indexed label that the textual input represents; and
identifying the one or more queries associated with the first indexed label as being selectable alternatives to the textual input.

5. The method of claim 4, further comprising:
comparing each query identified as being a selectable alternative to the queries in the query and label data to identify a first query that is textually identical to the query identified as being a selectable alternative; and
identifying the one or more labels that are associated with the first query as being selectable alternatives to the textual input.

6. The method of claim 4, wherein the textual input is not a substring of any of the selectable alternatives.

7. The method of claim 4, wherein the textual input is a prefix, midfix, or suffix of at least one of the selectable alternatives.

8. The method of claim 4, wherein identifying the first indexed label includes:
determining whether the textual input is a prefix of the first indexed label and determining that the first indexed label is represented by the textual input when the textual input is a prefix of the first index label.

9. The method of claim 1, wherein the queries are associated with at least one label that is not a substring of the associated query.

10. A computer-implemented method comprising:
receiving a textual input entered in a search engine query input field by a user; and
identifying input suggestions using a suggestion resource, the suggestion resource including an index of labels, each label being associated with one or more queries and identifying a category or topic in which an associated query belongs; wherein the identifying includes:
comparing the textual input to the indexed labels in the suggestion resource to identify a first indexed label that the textual input represents; and
identifying the one or more queries associated with the first indexed label as being selectable alternatives to the textual input.

11. A system comprising:
a machine-readable storage device including a program product; and
one or more processors operable to execute the program product and perform operations comprising:
receiving query and label data, the data including a plurality of queries and, for each query, specifying one or more labels associated with the query, wherein the queries are n-grams submitted by users of a search engine and the labels identify a category or topic in which an associated query belongs;
generating a suggestion resource, including:
identifying unique labels in the query and label data; and
for each unique label:
indexing the unique label;
identifying in the query and label data, each query associated with the unique label; and
associating, in the suggestion resource, the identified queries with the unique label; and
storing the suggestion resource in a computer-readable medium.

12. The system of claim 11, wherein the operations further comprise:
receiving a textual input entered in a search engine query input field by a user; and
identifying input suggestions using the query and label data including:
comparing the textual input to the queries in the query and label data to identify a first query that the textual input represents; and
identifying the one or more labels that are associated with the first query as being selectable alternatives to the textual input.

13. The system of claim 12, wherein the input suggestions are identified as characters are entered in the search engine query input field and before a complete query is submitted for a search.

14. The system of claim 11, wherein the operations further comprise:
receiving a textual input entered in a search engine query input field by a user; and
identifying input suggestions using the suggestion resource including:
comparing the textual input to the indexed labels in the suggestion resource to identify a first indexed label that the textual input represents; and
identifying the one or more queries associated with the first indexed label as being selectable alternatives to the textual input.

15. The system of claim 14, wherein the operations further comprise:
comparing each query identified as being a selectable alternative to the queries in the query and label data to identify a first query that is textually identical to the query identified as being a selectable alternative; and
identifying the one or more labels that are associated with the first query as being selectable alternatives to the textual input.

16. The system of claim 14, wherein the textual input is not a substring of any of the selectable alternatives.

17. The system of claim 14, wherein the textual input is a prefix, midfix, or suffix of at least one of the selectable alternatives.

18. The system of claim 14, wherein identifying the first indexed label includes:
determining whether the textual input is a prefix of the first indexed label and determining that the first indexed label is represented by the textual input when the textual input is a prefix of the first index label.

19. The system of claim 11, wherein the queries are associated with at least one label that is not a substring of the associated query.

20. A system comprising:
a machine-readable storage device including a program product; and
one or more processors operable to execute the program product and perform operations comprising:
receiving a textual input entered in a search engine query input field by a user; and
identifying input suggestions using a suggestion resource, the suggestion resource including an index of labels, each label being associated with one or more queries and identifying a category or topic in which an associated query belongs; wherein the identifying includes:
comparing the textual input to the indexed labels in the suggestion resource to identify a first indexed label that the textual input represents; and
identifying the one or more queries associated with the first indexed label as being selectable alternatives to the textual input.
